(19) United States
(12) Patent Application Publication
(10) Pub. No.: US 2018/0187871 A1
(43) Pub. Date: Jul. 5, 2018

(54) ILLUMINATOR SYSTEM WITH ADJUSTABLE FRAME

(71) Applicant: GE Lighting Solutions, LLC, East Cleveland, OH (US)

(72) Inventors: Shouyong ZHOU, ShangHai (CN); Honglei GAO, ShangHai (CN); Cuijuan ZHOU, ShangHai (CN); Hui LI, ShangHai (CN); Eric MEADOWS, East Cleveland, OH (US); JunQi REN, ShangHai (CN)

(21) Appl. No.: 15/851,828

(22) Filed: Dec. 22, 2017

(30) Foreign Application Priority Data
Dec. 30, 2016 (CN) 201611259392.9

(51) Int. Cl. F21V 21/14; F21S 8/02; F21V 17/12

(52) U.S. Cl. CPC F21V 21/14; F21V 17/12; F21S 8/026

(57) ABSTRACT

An illuminator system is disclosed, which comprises an adjustable frame comprising, a panel having an opening therein, defining an edge around the opening, and a frame member slidably mounted on the edge of the opening to move inward and backward so as to adjust a size of the opening; and an illuminator for being mounted inside the opening.

### BACKGROUND

This disclosure relates generally to an illuminating equipment, and more particularly to an illuminator system with an adjustable frame and an adjustable frame for mounting an illuminator.

When mounting a downlight, we open a hole on the ceiling, and put a mounting frame with an opening above the ceiling. Then, a downlight is mounted into the opening of the mounting frame. The downlight comprises two resilient retainers provided on the opposite sides thereof to retain the downlight on the edge of the opening.

However, when the opening is larger than the requirement of the downlight, the resilient force of the two resilient retainers on both sides will be uneven, which will lead to the failure of the spring of the resilient retainer. Another drawback of this is that there will be an uneven gap between the trim of the downlight and the ceiling, and there may be daylights passing out, when the trim of the downlight cannot cover the opening. Furthermore, the resilient retainer easily slides after installation, which will create an ugly appearance of this product.

Therefore, it is desirable to provide a solution to this problem.

### BRIEF DESCRIPTION

In one embodiment, the present disclosure provides an illuminator system, which comprises an adjustable frame comprising a panel having an opening therein, defining an edge around the opening, and a frame member slidably mounted on the edge of the opening to move inward and backward so as to adjust a size of the opening; and an illuminator for being mounted inside the opening.

In another embodiment, the present disclosure provides an adjustable frame comprising a panel having an opening therein, defining an edge around the opening, and a frame member slidably mounted on the edge of the opening to move inward and backward so as to adjust a size of the opening.

### DRAWINGS

These and other features and aspects of the present disclosure will become better understood when the following detailed description is read with reference to the accompanying drawings in which like characters represent like parts throughout the drawings, wherein:

FIG. 1 is a perspective view of an illuminator system in accordance with an embodiment;

FIG. 2 is a perspective view of an adjustable frame in accordance with an embodiment;

FIG. 3 is an exploded view of an adjustable frame in accordance with an embodiment;

FIG. 4 is perspective view of an illuminator system in accordance with another embodiment;

FIG. 5 is a perspective view of an adjustable frame in accordance with another embodiment;

FIG. 6 is an exploded view of an adjustable frame in accordance with another embodiment;

FIGS. 7A and 7B are illustrative views of the first and second frame member showing the adjustment of the aperture therein.

### DETAILED DESCRIPTION

Embodiments of the present disclosure will be described herein below with reference to the accompanying drawings. In the following description, well-known functions or constructions are not described in detail to avoid obscuring the disclosure in unnecessary detail.

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The terms such as “front”, “back”, “bottom”, and/or “top”, unless otherwise noted, are merely used for convenience of description, and are not limited to any one position or spatial orientation. The term “or” is meant to be inclusive and mean either or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect.

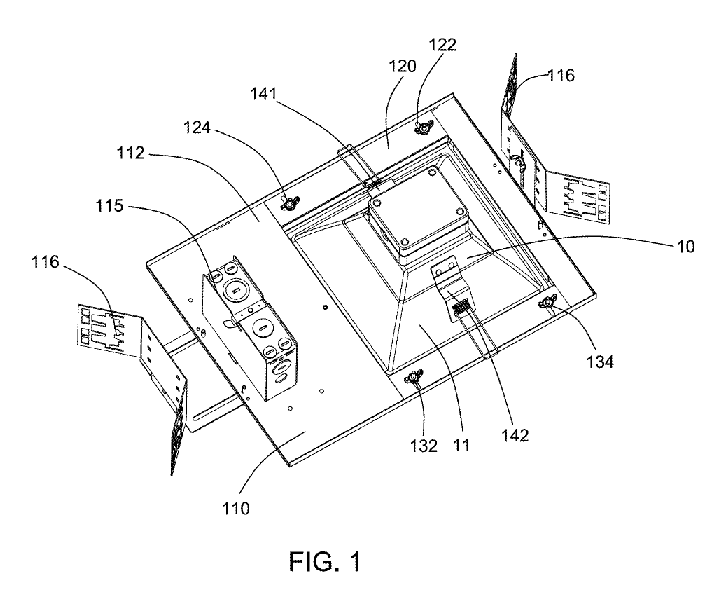

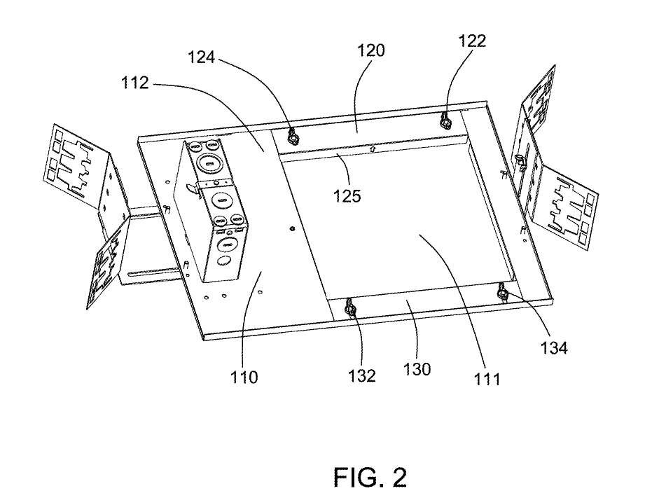

FIG. 1 illustrates a perspective view of an illuminator system with an adjustable frame in accordance with an embodiment. The illuminator system comprises an adjustable frame 100 and an illuminator 10. As shown in FIG. 2, the adjustable frame comprises a panel 110 having an opening 111 therein, defining an edge 112 around the opening; a frame member 120 slidably mounted on the edge 112 of the opening to move inward and backward so as to adjust a size of the opening. FIG. 1 shows a status of the frame member is moved inward to minimize the size of the opening 111, and FIG. 2 shows a status of the frame member is moved backward to enlarge the size of the opening 111. The illuminator 10 is for being mounted inside the opening 111. The frame member 120 has an elongated channel 121 thereon for receiving and moving relatively with a fixing member 122 on the edge of the opening. The frame member 120 comprises a wall plate 125 extending downwardly to cover the side of the opening 111.

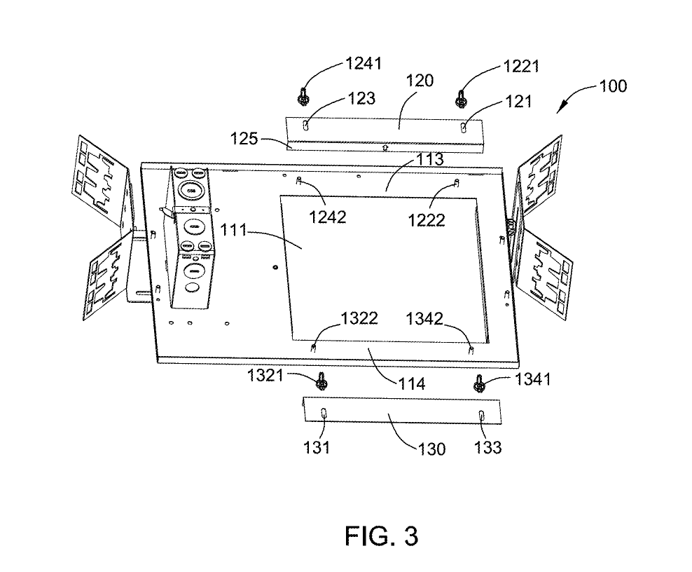

In an embodiment, referring to FIG. 3, the opening 111 is rectangle, in an embodiment square shaped, defining a first edge 113 and a second edge 114 on opposite sides of the opening, for mounting an illuminator, which is a square downlight in the embodiment. The frame member is a first frame member 120, and the adjustable frame comprises a second frame member 130. The first frame member 120 and the second frame member 130 are mounted on the first edge 113 and the second edge 114 respectively. The first frame member 120 has two elongated channels 121, 123 at two side edges thereon for receiving and move relatively with two fixing members 122, 124 respectively on the first edge 113. The fixing members 122 and 124 comprises screws 1222, 1242 provided on the first edge 113 respectively and butterfly nuts 1221, 1241 connecting with the screws 1222, 1242 for fixing the first frame member 120 to the first edge 113 of the opening. The second frame member 130 has very similar structure with the first frame member 120. The second frame member 130 has two elongated channels 131, 133 at two side edges thereon for receiving and move relatively with two fixing members 132, 134 respectively on the second edge 114. The fixing members 132 and 134 comprises screws 1322, 1342 provided on the second edge 114 respectively and butterfly nuts 1321, 1341 connecting with the screws 1322, 1342 for fixing the second frame member 130 to the second edge 114 of the opening.

In this embodiment, the frame member 120 and the second frame member 130 are both elongated rectangle shaped to align with the first edge 113 and the second edge 114 of the square opening 111. The first frame member 120 and the second frame member 130 has a length slightly shorter than the length of the first edge 113 and the second edge 114 of the opening 111, so as to fit in the opening.

The illuminator 10 is a downlight in the embodiment, which comprises a housing 11 and a light (not shown) disposed therein. The housing 11 comprises two resilient retainers 141,142 mounted on two sides on the back of the housing 11 for retaining the housing 11 to the edges 113, 114 of opening of the adjustable frame.

During the operation, the worker can loosen the butterfly nuts, move the first frame member and the second frame member, so as to change the relative position of the fixing members in the elongated channels. After putting the first frame member and the second frame member in the right position, the worker can fasten the butterfly nuts to fix the first frame member and the second frame member to the edge of the opening. Then put the back portion of downlight into the opening and retain the two resilient retainers on the edge of the opening.

In some other embodiment, the opening has other shapes, such as a round-shape, and the frame member has an arch shape which can align with the edge of the opening.

The adjustable frame further comprises a junction box 115 mounted on the panel 110 for connecting the wires of the illuminator 10 and the power line, and two brackets 116 mounted on two sides of the panel 110 for mounting the adjustable frame with the outside environment.

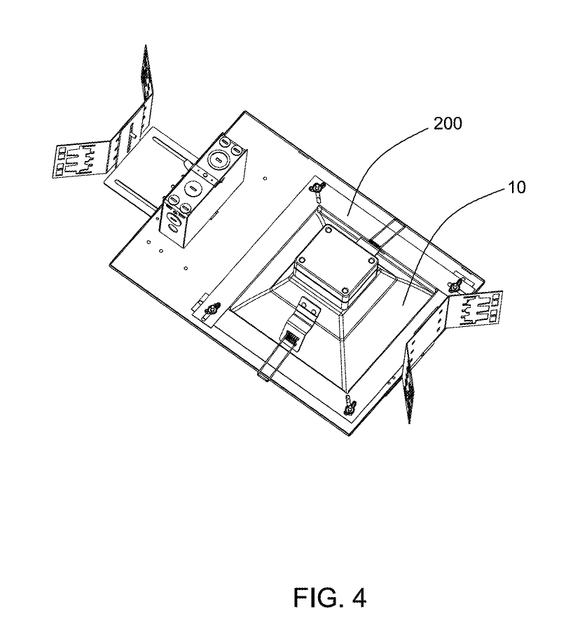

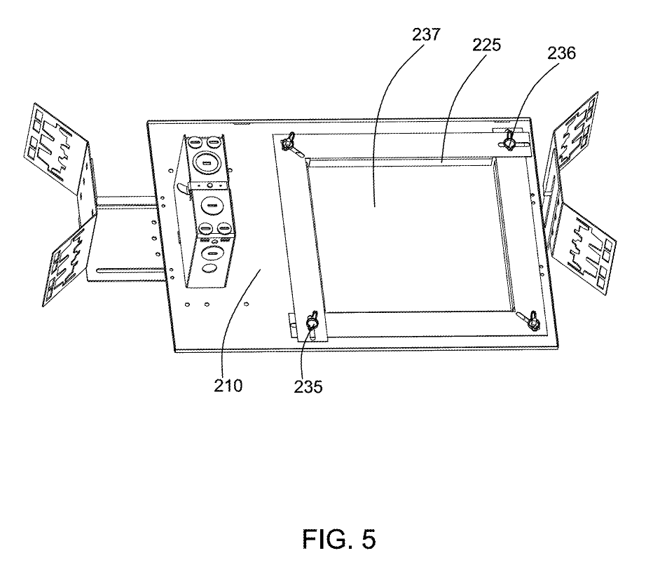

In another embodiment, referring to FIG. 4 of the drawings, the illuminator system comprises an adjustable frame 200 and an illuminator 10. Referring to FIG. 5, the adjustable frame comprises a panel 210 having an opening 211 therein, defining an edge 212 around the opening, and a first frame member 220 and a second frame member 230 slidably mounted on the edge 212 of the opening. The first frame member 220 comprises a first arm 221 and a second arm 223, and the second frame member 230 comprises a third arm 231 and a fourth arm 233, wherein the first arm and the fourth arm intersect and the second arm and the third arm intersect forming an aperture 237 therein to zoom in and out so as to adjust the size of the opening 211.

The first arm 221 has a first elongated slot 222 at an end edge thereof, the second arm 223 has a second elongated slot 224 at an end edge thereof, the third arm 231 has a third elongated slot 232 at an end edge thereof, and a fourth arm 233 has a fourth elongated slot 234 at an end edge thereof, wherein the first elongated slot and the fourth elongated slot overlap forming a first through hole 235, and the second elongated slot and the third elongated slot overlap forming a second through hole 236. A first guider 238 and a second guider 239 are provided in the first through hole and the second through hole respectively for guiding a movement of the first frame member 220 and the second frame member 230.

In an embodiment, the first frame member 220 is L-shaped, and in an embodiment the first arm 221 and the second arm 223 are orthogonal. The second frame member 230 is L-shaped, and in an embodiment the third arm 231 and the fourth arm 233 are orthogonal. And the opening 211 is rectangle defining a first edge 213, a second edge 214, a third edge 215 and a fourth edge 216 for mounting the first arm 221, the second arm 223, the third arm 231 and the fourth arm 233 respectively. The first arm 221, the second arm 223, the third arm 231 and the fourth arm 233 all comprises a wall plate 225 respectively extending downwardly to cover the four sides of the opening 211. In other embodiment, the opening 211 has other shapes, such as a hexagon, and the first frame member and the second frame member are mounted around the edge of the hexagon opening.

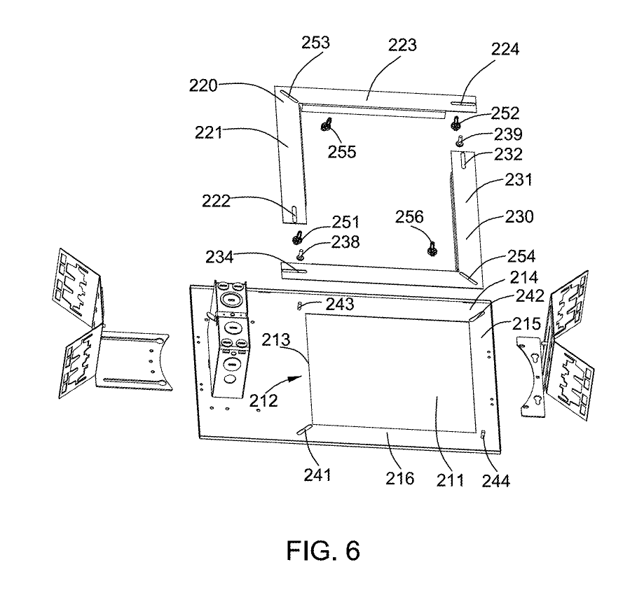

Referring to FIG. 6 of the drawings, in the embodiment, a first groove 241 is provided on the panel 210 between the first edge 213 and the fourth edge 216 extending along a diagonal line of the opening 211, and a second groove 242 is provided on the panel between the second edge 214 and the third edge 215 extending along the diagonal line of the opening, wherein the first guider 238 in the first through hole 235 extends into the first groove 241 to slide along the first groove, and the second guide 239 in the second through hole 236 extends into the second groove 242 to slide along the second groove. In another word, the first groove 241 and second groove 242 are provided on the opposite corners on the edges of the rectangle opening 211.

The first guider 238 and the second guider 239 comprises a first fastener 251 and a second fastener 252 respectively for fastening the first frame member 220 and the second frame member 230 through the first groove and second groove to the panel. The first guider 238 and the second guider 239 are screws. The first fastener 251 and the second fastener 252 are butterfly nuts.

A first connector 243 is provided on the panel 210 between the first edge 213 and the second edge 214 along another diagonal line of the opening 211, and a second connector 244 is provided on the panel 210 between the third edge 215 and the fourth edge 216 along another diagonal line of the opening 211. A first slit 253 is provided on the first frame member 220 between the first arm 221 and the second arm 223 extending along a diagonal line of the aperture 237 for receiving the first connector 243; and a second slit 254 is provided on the second frame member 230 between the third arm 231 and the fourth arm 233 extending along a diagonal line of the aperture 237 for receiving the second connector 244. When the first frame member 220 and the second frame member 230 move, the first slit 253 and the second slit 254 move relative to the first connector 243 and the second connector 244 respectively to guide the movement of the first frame member 220 and the second frame member 230.

A third fastener 255 is provided on the first slit 253 for fastening to the first connector 243, and a fourth fastener 256 is provided on the second slit 254 for fastening to the second connector 244. The third fastener 255 and the fourth fastener 256 are butterfly nuts.

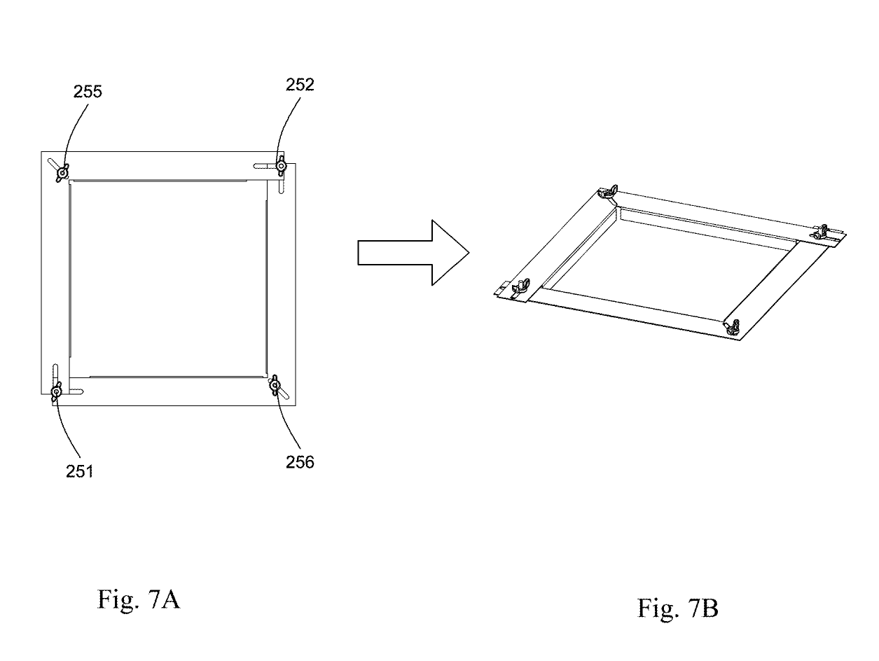

As shown in FIGS. 7A and 7B, the aperture 237 formed in the first frame member and the second frame member becomes smaller. When mounting the downlight into the opening of the adjustable frame, the worker firstly loosens all the butterfly nuts, to adjust the first frame member and the second frame member to zoom in or out the aperture 237, and then fastens all the butterfly nuts to fasten the first frame member and the second frame member to the panel. And then put the downlight into the opening same with the first embodiment.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An illuminator system, comprising:
an adjustable frame comprising,
a panel having an opening therein, defining an edge around the opening, and
a frame member slidably mounted on the edge of the opening to move inward and backward so as to adjust a size of the opening; and
an illuminator for being mounted inside the opening.

2. The illuminator system of claim 1, wherein the frame member has an elongated channel thereon for receiving and moving relatively with a fixing member on the edge of the opening.

3. The illuminator system of claim 2, wherein the fixing member comprises a butterfly nut for fixing the frame member to the edge of the opening.

4. The illuminator system of claim 1, wherein the frame member is a first frame member comprising a first arm and a second arm, and the adjustable frame comprises a second frame member slidably mounted on the edge of the opening comprising a third arm and a fourth arm, wherein the first arm and the fourth arm intersect and the second arm and the third arm intersect forming an aperture therein to zoom in and out so as to adjust the size of the opening.

5. The illuminator system of claim 4, wherein the first arm has a first elongated slot at an end edge thereof and the second arm has a second elongated slot at an end edge thereof, the third arm has a third elongated slot at an end edge thereof and a fourth arm has a fourth elongated slot at an end edge thereof, wherein the first elongated slot and the fourth elongated slot overlap forming a first through hole, and the second elongated slot and the third elongated slot overlap forming a second through hole, and a first guider and a second guider are in the first through hole and the second through hole respectively for guiding a movement of the first frame member and the second frame member.

6. The illuminator system of claim 5, wherein the first arm and the second arm are orthogonal, and the third arm and the fourth arm are orthogonal, and the opening is rectangle defining a first edge, a second edge, a third edge and a fourth edge for mounting the first arm, the second arm, the third arm and the fourth arm respectively.

7. The illuminator system of claim 6, wherein a first groove is provided on the panel between the first edge and the fourth edge extending along a diagonal line of the opening, and a second groove is provided on the panel between the second edge and the third edge extending along the diagonal line of the opening, wherein the first guider in the first through hole extends into the first groove to slide along the first groove, and the second guide in the second through hole extends into the second groove to slide along the second groove.

8. The illuminator system of claim 7, wherein a first connector is provided on the panel between the first edge and the second edge along another diagonal line of the opening, and a second connector is provided on the panel between the third edge and the fourth edge along another diagonal line of the opening, wherein a first slit is provided on the first frame member between the first arm and the second arm extending along a diagonal line of the aperture for receiving the first connector; and a second slit is provided on the second frame member between the third arm and the fourth arm extending along a diagonal line of the aperture for receiving the second connector.

9. An adjustable frame for mounting an illuminator 10, comprising:
a panel having an opening therein, defining a first edge and a second edge on opposite sides of the opening; and
a first frame member and a second frame member are slidably mounted on the first edge and the second edge of the opening respectively to move inward and backward so as to adjust a size of the opening.

10. The adjustable frame of claim 9, wherein the frame member and the second frame member are both elongated rectangle shaped.
